(19) United States
(12) Patent Application Publication
(10) Pub. No.: US 2002/0000157 A1
(43) Pub. Date: Jan. 3, 2002

(54) MANUALLY-OPERATED SYNCHRONIZING VALVE FOR PAIRED HYDRAULIC CYLINDERS

(76) Inventor: PAUL R. SPRATT, MAPLE GROVE, MN (US)

Correspondence Address: WALTER C LINDER, FAEGRE AND BENSON LLP, 2200 NORWEST CENTER, 90 SOUTH SEVENTH STREET, MINNEAPOLIS, MN, 554023901

(21) Appl. No.: 09/429,277

(22) Filed: Oct. 29, 1999

(51) Int. Cl. F15B 11/22

(52) U.S. Cl. 91/171

(57) ABSTRACT

A hydraulic valve system for controlling and synchronizing the flow of hydraulic fluid to a set of first and second hydraulic actuators powered by a single control valve work section. The system includes a primary control valve or valves and a synchronizing control valve. The primary control valve is actuated to control the flow of hydraulic fluid between a source of pressurized hydraulic fluid and both the first and second cylinders, and includes an input port connected to the source of pressurized hydraulic fluid and an output port connected in a parallel hydraulic circuit to both the first and second cylinders. The synchronizing control valve is actuated to synchronize the flow of hydraulic fluid from the primary control valve to the first and second hydraulic cylinders by bleeding a portion of the flow of hydraulic fluid supplied to one of the cylinders to the tank. The synchronizing control valve has first and second input ports and an output port. The first synchronizing valve input port is connected to the first hydraulic cylinder. The second synchronizing valve input port is connected to the second hydraulic cylinder. The output port of the synchronizing valve is connected to the tank. Using the synchronizing valve an operator can easily and effectively synchronize the relative travel speed of the two cylinders.

### FIELD OF THE INVENTION

The present invention relates generally to hydraulic systems. In particular, the invention is a hydraulic system including a manually-operated synchronizing valve for evenly distributing hydraulic fluid flow between paired cylinders.

### BACKGROUND OF THE INVENTION

Many hydraulic systems use two or more cylinders or other actuators to drive a load. In these applications the “paired” cylinders are typically connected in a parallel hydraulic circuit to the work section of a single control valve. Hydraulic fluid flow from the control valve is thereby distributed to each of the cylinders. In-line flow dividers or orifices are sometimes incorporated into systems of this type to divide the fluid flow between the cylinders in desired proportions (e.g., equally). However, these dividers are subject to tolerance variations and system differentials which can cause the flow between the cylinders to vary from the desired proportions.

By way of example, hydraulic systems used to raise and lower ramps or platforms which are used to support relatively heavy objects (e.g., ramps on trucks used to transport cars and other vehicles) often have a pair of transversely-spaced hydraulic cylinders connected to a common control valve. If the loads supported by these ramps or platforms are unevenly distributed, or if the mechanical efficiencies of the cylinder linkages vary or change, the pressures required to drive the cylinders will be different. Since fluid will flow to the lightest load first in these hydraulic systems, the uneven load distribution can cause the platform to twist. This action may continue until a binding occurs, and the force required to continue movement of the advancing cylinder equalizes with that of the trailing cylinder. In addition to other potential consequences, this action results in the uneven raising and lowering of the ramp or platform.

It is evident that there is a continuing need for improved approaches for controlling the relative flow of hydraulic fluid between paired cylinders actuated by a common control valve. To be commercially viable, any such system should be effective and capable of being efficiently implemented. A system of this type which can be controlled by an operator would be especially desirable.

### SUMMARY OF THE INVENTION

The present invention is a synchronizing valve arrangement for controlling the flow of hydraulic fluid between a tank and a set of hydraulic cylinders or other actuators. It enables an operator to easily and accurately synchronize or otherwise control the relative speed of two actuators powered by a single control valve work section. The valve arrangement is also capable of being efficiently implemented.

One embodiment of the valve arrangement includes a set of at least two actuator ports, a primary control valve and a synchronizing control valve. Each actuator port of the set couples hydraulic fluid flow to one of a set of at least two hydraulic actuators. The primary control valve commonly controls the flow of hydraulic fluid between the tank and all the actuator ports of the set. The synchronizing valve individually controls the flow of hydraulic fluid between each actuator port of the set and the tank, to synchronize the primary control valve-controlled flow of hydraulic fluid through the actuator ports.

### BRIEF DESCRIPTION OF THE DRAWINGS

FIG. 1 is a schematic diagram of a hydraulic valve system in accordance with the present invention. The valve system is shown interconnected to two pairs of hydraulic cylinders and to a hydraulic fluid supply system.

### DETAILED DESCRIPTION OF THE PREFERRED EMBODIMENTS

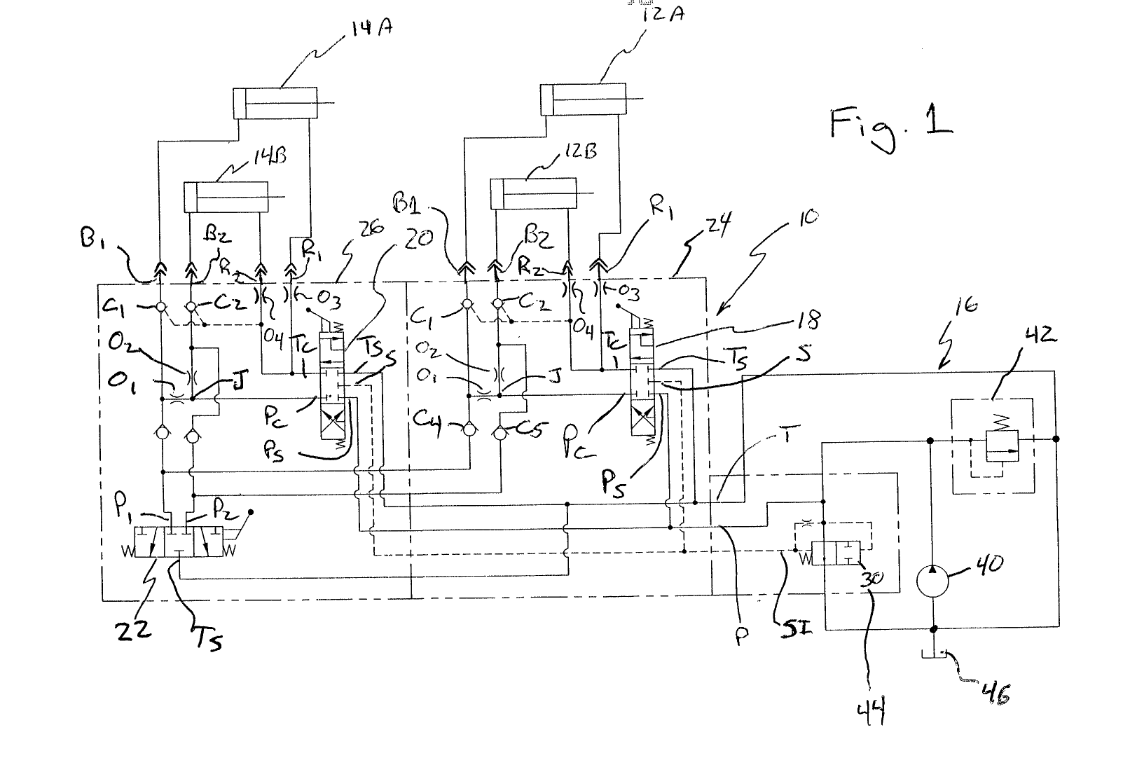

One preferred embodiment of the hydraulic valve system 10 of the present invention is illustrated in FIG. 1. In this particular embodiment the valve system 10 is configured for interconnection to first and second sets of double acting hydraulic cylinders (i.e., actuators) 12A, 12B and 14A, 14B, respectively. The valve system 10 is also interconnected to hydraulic fluid supply system 16. Although not shown, each set of cylinders 12A, 12B and 14A, 14B can be mounted to and operated to raise and lower a ramp or platform, or to otherwise actuate a structure or device. First primary control valve 18 is connected to the first set cylinders 12A and 12B in a parallel hydraulic circuit and operated to simultaneously control both cylinders of the first set. Similarly, second primary control valve 20 is connected to the second set cylinders 14A and 14B in a parallel hydraulic circuit and operated to simultaneously control both cylinders of the second set. A synchronizing valve 22 is connected between each set of cylinders 12A, 12B and 14A and 14B and the associated primary control valve 18 and 20, respectively. By operating the synchronizing valve 22 when one or both of the primary control valves 18 and 20 is also being operated to extend or retract the associated set of cylinders 12A, 12B and/or 14A and 14B, an operator can synchronize or otherwise control the relative travel speeds of the two cylinders of the set. This functionality enables an operator to manually adjust for travel speed differences and provide improved positioning control.

In the embodiment shown, primary control valve 18 is a manually-actuated, double-acting, closed center spool valve in block 24. Valve block 24 has a set of first and second base ports B₁ and B₂ (i.e., a first set of base ports) which are adapted to be connected to the base ends of cylinders 12A and 12B, respectively, and a set of first and second rod ports R₁, and R₂ (i.e., a first set of rod ports) which are adapted to be connected to the rod ends of cylinders 12A and 12B, respectively. The working section of primary control valve 18 has a supply side pressure port Pₛ (i.e., an input port) connected to the pressure port P of the hydraulic fluid supply system 16 and a supply side tank port Tₛ connected to the tank port T of the hydraulic fluid supply system. On the cylinder side of the control valve 18, the working section has a pressure port P_{c} (i.e., an output port) which is connected in parallel from junction J to both base ports B₁ and B₂ through orifices O₁ and O₂ and check valves C₁ and C₂, respectively. Both rod ports R₁ and R₂ of the valve block 24 are connected to the tank port T_{c} (also an output port) on the cylinder side of the working section of the valve 18. The sensing port S of the valve 18 is connected to the sensing input SI of an unloader valve 30 in the hydraulic fluid supply system 16. Check valves C₁ and C₂ prevent load-induced drift-down of cylinders 12A and 12B, and in the embodiment shown are pilot-operated devices which have their sensing inputs connected to the rod port R₂ of valve block 24. Orifices O₁ and O₂ can be used to enhance the accuracy of the differential fluid flow to the ports B₁ and B₂. Port restrictions O₃ and O₄ can be included in valve block 24 adjacent to rod ports R₁, and R₂, respectively, to enhance the stability of system 10 when lowering heaving loads.

Synchronizing valve 22 also is a manually-actuated, double acting spool valve in the embodiment shown, and can be mounted within a valve block such as 26. In this configuration the cylinder side of the working section of the synchronizing valve 22 has a pair of ports P₁ and P₂ (i.e., input ports) which are connected to base ports B₁ and B₂, respectively, of the valve block 24. This connection is made at locations between the respective check valves C₁ and C₂ and orifices O₁ and O₂ in the embodiment shown. A pair of check valves C₄ and C₅ are included in the fluid flow paths between the ports P₁ and P₂ of synchronizing valve 22 and base ports B₁ and B₂, respectively, of the valve block 24. A tank port Tₛ (i.e., an output port) of the synchronizing valve 22 is connected to the tank port T of the hydraulic fluid supply system 16 through the valve block 24.

The second primary control valve 20 is a manually-actuated, double-acting, closed center spool valve mounted within the valve block 26 in the embodiment shown. Valve block 26 has a set of first and second base ports B₁ and B₂ (i.e., a second set of base ports) which are adapted to be connected to the base ends of cylinders 14A and 14B, respectively, and a set of first and second rod ports R₁ and R₂ (i.e., a second set of rod ports) which are adapted to be connected to the rod ends of cylinders 14A and 14B, respectively. The working section of primary control valve 20 has a supply side pressure port Pₛ connected to the pressure port P of the hydraulic fluid supply system 16 and a supply side tank port Tₛ connected to the tank port T of the hydraulic fluid supply system, both through the valve block 24. On the cylinder side of the control valve 20, the working section has a pressure port P_{c} which is connected in parallel from junction J to both base ports B₁ and B₂ through orifices O₁ and O₂ and check valves C₁ and C₂, respectively. Both rod ports R₁ and R₂ of the valve block 26 are connected to the tank port T_{c} on the working section cylinder side of the valve 20. The sensing port S of the valve 20 is connected to the sensing input SI of the unloader valve 30 in the hydraulic fluid supply system 16 through the valve block 24. Check valves C₁ and C₂ prevent load-induced drift-down of cylinders 14A and 14B, and in the embodiment shown are pilot-operated devices which have their sensing inputs connected to the rod port R₂ of valve block 26.

The fluid supply system 16 includes the unloader valve 30, pump 40 and relief valve 42. The unloader valve 30 is shown mounted within a block 44. Valve blocks 24,26 and 44 are mounted together in a bank in the embodiment shown. Pressurized hydraulic fluid from pump 40 is coupled to the pressure port P of supply system 16 though the block 44. The tank port T of the supply system 16 is coupled to a tank 46 of hydraulic fluid through the block 44. As shown, unloader valve 30 is also connected to both the pressure port P and tank 46 of hydraulic fluid supply system 16.

During the operation of valve system 10, the pump 40 will provide a continuous supply of pressurized hydraulic fluid to pressure port P. As long as both primary control valves 18 and 20 are not actuated, their sensing ports S causes the unloader valve 30 to be in an open state, shunting the supply of pressurized fluid back to the tank 46. However, if either or both of primary control valves 18 and 20 are actuated to raise or lower their respective set of cylinders 12A, 12B and 14A, 14B, the associated sensing port S will cause the unloader valve 30 to switch to its closed state, and thereby supply fluid to the supply side pressure port Pₛ of the actuated control valve(s). The control valves 18 and/or 20 can thereby be operated to control the flow of fluid, in a parallel hydraulic circuit, to the associated base ports B₁ and B₂ or rod ports R₁ and R₂, and thereby raise and/or lower the respective set of cylinders 12A, 12B, and/or 14A, 14B.

Synchronizing valve 22 can be actuated by the operator during the actuation of primary control valves 18 and/or 20 to synchronize the motion of the cylinders 12A, 12B and/or 14A, 14B, respectively, being driven. By operating the synchronizing valve 22, fluid flow to a selected one of cylinders 12A and 12B (if primary control valve 18 is being actuated) and/or a selected one of cylinders 14A and 14B (if primary control valve 20 is being actuated) is shunted or bled off and returned to tank port T. By way of example, if the primary control valve 18 is actuated in such a manner that its supply side pressure port Pₛ is fluidly connected to the cylinder side pressure port P_{c}, thereby providing pressurized hydraulic fluid to the base ends of cylinders 12A and 12B through ports B₁ and B₂, respectively, the relative travel speed of cylinder 12A can be slowed with respect to that of cylinder 12B by actuating synchronizing valve 22 in such a manner as to connect its cylinder side port P₁ to its tank port Tₛ. This action will cause some of the pressurized hydraulic fluid that would otherwise flow to the base end of the cylinder 12A through port B1 to instead flow to the tank 46. In a similar manner, the relative speed of cylinder 12B can be slowed with respect to cylinder 12A if the primary control valve 18 is actuated in the manner described above by actuating the synchronizing valve 22 in the opposite direction to connect its cylinder side port P₂ to its tank port Tₛ. The relative speed of cylinders 14A and 14B can be controlled by synchronizing valve 22 in a similar manner when the second primary control valve 20 is being actuated to drive the cylinders 14A and 14B. Synchronizing valve 22 can also be operated to synchronize the motion of cylinders 12A and 12B and/or 14A and 14B when the respective primary control valves 18 and/or 20 are actuated to supply pressurized hydraulic fluid to the rod ends of the cylinders.

The synchronizing valve offers a number of important advantages. It allows an operator to relatively easily and accurately synchronize the motion of a pair of cylinders or other hydraulic actuators. Positioning control can thereby be enhanced. The system can also be efficiently implemented. One synchronizing valve can be used to provide the synchronizing function to one or more cylinders (i.e., it can be incorporated into a multiple section valve bank).

Although the present invention has been described with reference to preferred embodiments, those skilled in the art will recognize that changes can be made in form and detail without departing from the spirit and scope of the invention. For example, valve control and synchronization can be accomplished with lever, solenoid, pneumatic spool or other valve configurations. Open center and other valve configurations can also be used. Although shown in connection with cylinders, the synchronization approach can be used with other hydraulic actuators such as motors. The system can also be configured to synchronize the relative travel speed of a set of three or more actuators.

What is claimed is:

1. A synchronizing valve arrangement for controlling the flow of hydraulic fluid between a tank and a set of hydraulic actuators, including:
set of at least two actuator ports, each port of the set for coupling hydraulic fluid flow to one of a set of at least two hydraulic actuators;
a primary control valve for commonly controlling the flow of hydraulic fluid between the tank and all the actuator ports of the set; and
a synchronizing valve for individually controlling the flow of hydraulic fluid between each actuator port of the set and the tank, to synchronize the primary control valve-controlled flow of hydraulic fluid through the actuator ports.

2. The valve arrangement of claim 1 wherein the primary control valve is a spool valve.

3. The valve arrangement of claim 2 wherein the control valve is a manually-actuated spool valve.

4. The valve arrangement of claim 3 wherein the synchronizing valve is a manually-actuated spool valve.

5. The valve arrangement of claim 2 wherein the synchronizing valve is a spool valve.

6. The valve arrangement of claim 1 and further including:
hydraulic cylinders connected to the actuator ports;
a pump connected to the primary control valve; and
a hydraulic fluid tank connected to the primary control valve and synchronizing valve.

7. A hydraulic valve system for controlling and synchronizing the flow of hydraulic fluid to a first set of first and second hydraulic actuators, including:
a first set of first and second hydraulic actuator ports, for connection to first and second hydraulic actuators;
a first primary control valve for controlling the flow of hydraulic fluid between a source of pressurized hydraulic fluid and the first set of actuator ports, the control valve comprising:
an input port for connection to the source of pressurized hydraulic fluid; and
an output port connected in a parallel hydraulic circuit to the first and second actuator ports; and
a synchronizing control valve for synchronizing the flow of hydraulic fluid from the first primary control valve to the first set of hydraulic actuator ports by controlling the flow of hydraulic fluid between the first and second hydraulic actuator ports and a tank of the hydraulic fluid, the synchronizing control valve comprising:
a first input port connected to the first hydraulic actuator port;
a second input port connected to the second hydraulic actuator port; and
an output port for connection to the tank of hydraulic fluid.

8. The hydraulic valve system of claim 7 and further including orifices between the output port of the first primary control valve and the first and second hydraulic actuator ports.

9. The hydraulic valve system of claim 7 wherein the first primary control valve is a manually-actuated spool valve.

10. The hydraulic valve system of claim 7 for controlling the flow of hydraulic fluid to a first set of double acting hydraulic cylinders, and wherein the first primary control valve is a double acting spool valve.

11. The hydraulic valve system of claim 10 wherein the synchronizing control valve is a spool valve.

12. The hydraulic valve system of claim 11 wherein the synchronizing control valve is a double acting spool valve.

13. The hydraulic valve system of claim 12 and further including:
a first check valve between the first hydraulic actuator port and both the first primary control valve and the synchronizing control valve; and
a second check valve between the second hydraulic actuator port and both the first primary control valve and the synchronizing control valve.

14. The hydraulic valve system of claim 12 and further including:
a second set of first and second hydraulic actuator ports, for connection to a second set of first and second hydraulic actuators;
a second double acting primary control spool valve for controlling the flow of hydraulic fluid between the source of pressurized hydraulic fluid and the second set of actuator ports, the second control valve comprising:
an input port for connection to the source of pressurized hydraulic fluid; and
an output port connected in a parallel hydraulic circuit to the first and second actuator ports of the second set; and
wherein the first input port of the synchronizing control valve is connected to the first actuator port of the second set of actuator ports, the second input port of the synchronizing control valve is connected to the second actuator port of the second set of actuator ports, enabling the synchronizing control valve to synchronize the flow of hydraulic fluid from the second primary control valve to the second set hydraulic actuator ports by controlling the flow of hydraulic fluid between the first and second hydraulic actuator ports of the second set and the tank of hydraulic fluid.

15. The hydraulic valve system of claim 7 and further including:
a second set of first and second hydraulic actuator ports, for connection to a second set of first and second hydraulic actuators;
a second primary control valve for controlling the flow of hydraulic fluid between the source of pressurized hydraulic fluid and the second set of actuator ports, the second control valve comprising:
an input port for connection to the source of pressurized hydraulic fluid; and
an output port connected in a parallel hydraulic circuit to the first and second actuator ports of the second set; and
wherein the first input port of the synchronizing control valve is connected to the first actuator port of the second set of hydraulic actuator ports and the second input port of the synchronizing control valve is connected to the second actuator port of the second set of hydraulic actuator ports, enabling the synchronizing control valve to synchronize the flow of hydraulic fluid from the second primary control valve to the second set hydraulic actuator ports by controlling the flow of hydraulic fluid between the first and second hydraulic actuator ports of the second set and the tank of hydraulic fluid.

16. The hydraulic valve system of claim 15 and further including:
a first set of hydraulic cylinders coupled to the first set of hydraulic actuator ports;
a second set of hydraulic cylinders coupled to the second set of hydraulic actuator ports;
a pump connected to the first and second primary control valves; and
a hydraulic fluid tank connected to the first and second primary control valves and the synchronizing valve.

17. The hydraulic valve system of claim 7 and further including:
a first set of hydraulic cylinders coupled to the first set of hydraulic actuator ports;
a pump connected to the first primary control valve; and
a hydraulic fluid tank connected to the first primary control valve and the synchronizing valve.
